(19) United States
(12) Patent Application Publication
(10) Pub. No.: US 2003/0094541 A1
(43) Pub. Date: May 22, 2003

(54) Security & anti suicide-hijacking system for airplanes

(76) Inventor: Rashid A. Zeineh, Fullerton, CA (US)

Correspondence Address: Biomed Instruments Inc, 1166 E. Valencia Dr., Fullerton, CA, 92831, US

(21) Appl. No.: 09/987,784

(22) Filed: Nov. 16, 2001

(51) Int. Cl. B64D 11/00; B64D 13/00

(52) U.S. Cl. 244/118.5

(57) ABSTRACT

The present invention relates to preventing one or a group of suicide hijackers from taking over control of an airplane and crashing it onto public facility such as a building, city, dam, atomic reactor, or ship for the purpose of causing mass destruction and killing of innocent civilians. This invention comprises multiple defense stations inside the passengers cabin. Each station has a motorized defense tool, video camera viewer with remote controller is in front of the pilot and in airline, FBI, and CIA headquarters. Each station has one of the following; a defense tool, a gun with silencer, stunt gun, tranquilizer, MACE or pepper sprayer, arrow thrower with high voltage electric charge, wood hammer, head banger, stomach puncher, foot tripper and trap, head holder, waist grabber, or a leg trapper or breaker as one of the stunt none-lethal and no permanent damage to immobilize the intruders. The locations of defense stations includes cabin ceiling above the center isle, cabin floor below walk isle, inside cabin side walls, rear of cabin, cockpit door, and inside cockpit. Line of fire is above isle stretch and above the heads of sitting passengers. Video cameras are mounted on these defense tools that are motorized for direction and for automatic firing. Remote viewing of gun sight field, remote aiming, and firing by pilot or by central or regional location of Police, InterPol, FBI, CIA, FAA, army, or headquarters allows the pilot or commanding post to act in defense, immobilize, physically knockdown, or tranquilize the one or multiple hijackers. The video and sound connection as well as pointing and firing are in realtime communication via internet, radio, cellular, or satellite means. An automatic recognition of intruder sitting on pilot's seat is by few parameters such weight, skin color, color of eyes, and voice according to past flyers and airline listed pilots employees. A computer and a GPS system on board the airplane reads the GPS of plane in flight and reads an on file list of on ground GPSs of sensitive potential terror targets nationally and international locations such as atomic reactors, building, and dams that are filed into computer and its backup computer. If the plane flight is below 2000 feet and is approaching a GPS potential target the computer automatically overrides the intruder pilot to turn left by temporary mechanical locking tail left flap or tail flap up. Another security item is kite-like controlled opening parachute for the plane for slow vertical speed and slow horizontal speed to lower the chances of injuries and damage.

### TECHNICAL FIELD

The present invention relates to security of airplane and property. After Sep. 11, 2001 attack the USA is considering air marshals on every flight, luggage imaging, extensive checking on passengers history & profiling, checking terrorists and wanted listings, and other complicated un-assuring measures that have many draw backs and limitations. World wide and American people do not feel safe now. Big buildings, dams, atomic reactors, ships, underground transportation, freedom, landmarks, dense civilian locations, and democracy remain in danger.

### BACKGROUND ART

The present invention relates to security of airplanes against suicide hijackers intending to crash into facilities and to cause mass destruction and killings of innocent people. The Sep. 11, 2001 attack on World Trade Center in New York and on the Pentagon in Washington D.C. that killed thousands of innocent people shows that current security on air travel is inadequate. Government plan for air marshals, checking passengers against suspected terrorists lists, improved baggage imaging and more training for employees do not bring back feeling safe.

### DISCLOSURE OF THE INVENTION

The present invention relates to security of airplanes against hijacking followed by suicide crashing into cities, buildings, dams, atomic reactors, and facilities. This invention comprises multiple defense stations inside the passenger's cabin and in cockpit. Each station has a motorized defense weapon, video camera viewer, and a remote controller in front of the pilot. Each station has one or more of the following items; a stun gun, tranquilizer, a gun with silencer and safety rubber bullets or double hollow point aluminum stun bullets, arrow with high voltage electric charge, wood or rubber hammer, head banger, stomach puncher, foot tripper and trap, or a leg hurler or breaker. Locations of defense stations include cabin ceiling above the isle, below isle floor, inside side walls of passenger cabin, rear of cabin, cockpit door, and inside cockpit in front seated pilot on dashboard, on pilots seat, and in cockpit ceiling. Line of fire is above isle stretch and above the heads of sitting passengers. Video cameras are mounted on these defense articles that are motorized for direction and for automatic firing. Remote viewing of video designators of sight field, remote aiming, and defense action by pilot or by central or regional location of Police, InterPol, FBI, CIA, FAA, army, or world wide headquarters allows the pilot or commanding post to immobilize or physically knockdown or tranquilize and capture the one or multiple hijackers. The video and sound connection as well as aiming and firing are in realtime video-audio-mechanical communication via internat, radio, cellular, or satellite means. A computer and backup with on-plane global positioning system (GPS) location reader and height and speed and overriding turn by evasive temporary mechanical locking the tail flaps side turn for evasive action of listed GPS landmarks as the White House, Eiffel Tower, atomic reactor, and dams allowing affiliated headquarters to temporarily remote-control flight namely to prevent intruder or crazy pilot from crashing the plane on any of listed sensitive targets listed by computer programs.

### BRIEF DESCRIPTION OF THE DRAWINGS:

FIG. 1. Airplane passengers' cabinet with passengers 23 with hijacker 21 with multiple defense stations each consisting of tranquilizer gun 25, video designator-viewer, and microphone-speaker.

FIG. 2. Activated cockpit monitor with pilot 33 in cockpit in front of activated monitor 34 viewing multiple highjackers 35, 36, 37, & 38.

FIG. 3. Remote control monitors fwith pilot on his computer screen 41 alerts relevant agencies42, 43, and 44 via realtime video conferencing to share view in FIG. 2 and to act to immobilize the attackers with tranquilizer, stunt arrow, knockdown mechanism, or safety bullets

FIG. 4. Passengers cabinet with intruder 21 walking on the center isle.

FIG. 5. Passengers cabinet with two Intruders 51 and 21 walking center isle 52.

FIG. 6. Passengers cabinet with intruder 21 walking on center isle 52.

FIG. 7. Passengers cabinet with action on intruder 21 on center isle with floor foot trap-hold 53, tranquilizer defense station 56, body trapper-holder 54 and spray squirt defense station 55.

FIG. 8. Defense and communication station consisting of guiding mechanics 57, thrower 58, thrown defense item 59, audio 60, video 29, supply of thrown items 61, and power 62.

FIG. 9. Passengers and cockpit cabinets with viewing and defense stations for FAA, airlines, and pilot remote-control monitors. The stations are hidden for defense-communication stationsand for aiming at intruders walking on center isle 52, cabinet ceiling station 63, intruder trapper 54, side station on cabinet wall 25, isle defense 64, cockpit defense 65, and defense-communication audio visual 66 looking and licensing to the pilot, black box cockpit recorder 67, tranquilizer 71, cockpit door guard station aiming along the center (s), floor foot trapper-holder 69, and under isle defense station 68.

### DETAILED DESCRIPTION OF THE DRAWINGS

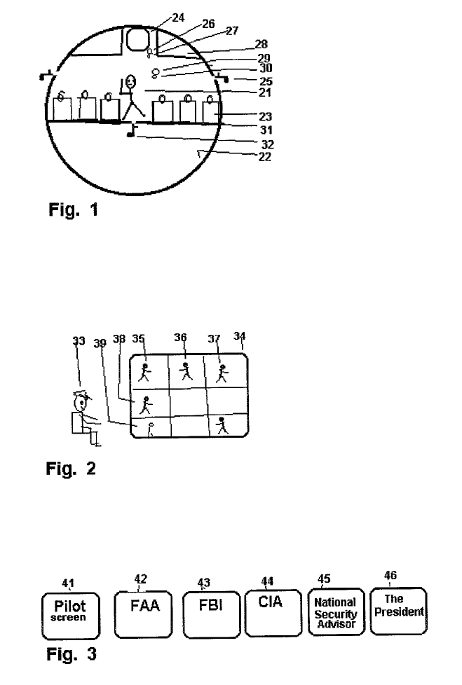

FIG. 1. Airplane passengers' cabinet, passenger 23 with hijacker 21 with multiple defense stations each consisting of tranquilizer gun 26 and 27, video designator-viewer 26 and 29. Viewer and gun 26 and 32 are showing guns and viewers separately. Each station has a speaker & microphone for sound communication.

FIG. 2. Cockpit cabinet with pilot 33 in cockpit in front of activated monitor 34 viewing multiple highjackers 35, 36, 37, & 38. Passenger 39 appears on one station

FIG. 3. Computer monitors for remote control for headquarters and pilot sitting in the cockpit. Pilot in front of his computer monitor 41 in cockpit as he was alerted and he turns his monitor to see 9 or more subscreens as in FIG. 2. Pilot can take action by remote control of cabin defense stations five of which are seen in FIG. 1. Pilot can talk to the offender to cooperate. Pilot can chose the weapon, time, and location to immobilize the offender using the appropriate procedure. Pilot can alert any or all agents to evaluate the risk. Every agency can see the offender or offenders and take action independently or in concert. Alerted agencies 42, 43, and 44 can consult with each other via satellite through a real-time video conferencing to share the 9 or more fields of cameras' as seen in FIG. 2 and to act individually or in concert to immobilize the attackers with tranquilizer, stunt arrow, knockdown mechanism, leg breaking mechanism, or using safety bullets that immobilize human target but disintegrate when hitting a solid material as walls or floor of passengers cabin.

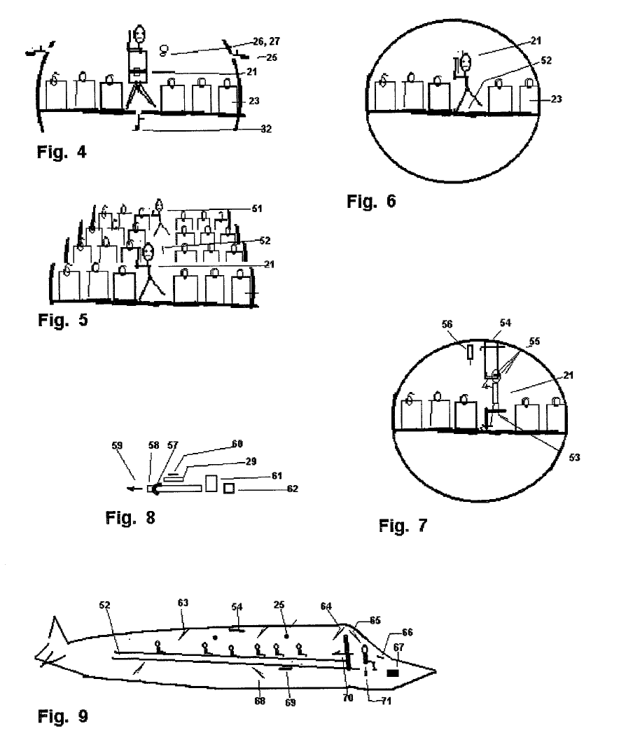

FIG. 4. Intruder 21 walking on the center isle. FAA, airlines, or employed pilot has remote control defense stations aimed at intruder for capturing him and temporarily immobilizing him.

FIG. 5. Intruders 51 and 21 walking center isle 52 of passengers cabinet.

FIG. 6. Intruder 21 walking on center isle 52. Passengers 23 are seated.

FIG. 7. Intruder 21 on center isle with center isle floor foot-trap-hold 53, tranquilizer defense station 56, body trapper-holder 54 and spray squirt Freon, pepper, or anesthetic defense station 55.

FIG. 8. Defense and communication station consisting of guidance mechanics 57, thrower 58, thrown defense item 59, audio 60, video 29, supply of thrown items 61, and electrical or power drive 62.

FIG. 9. Passengers and cockpit cabinets with viewing and defense stations for FAA, airlines, and pilot remote-control monitors and hidden defense-communication stations aiming at intruders walking on center isle 52, cabinet ceiling station 63, intruder trapper 54, side station on cabinet wall 25, isle defense 64, cockpit defense 65, and defense-communication audio visual 66 looking and licensing to the pilot, black box cockpit recorder 67, tranquilizer 71, cockpit door guard station aiming along the center (s), floor foot trapper-holder 69, and under isle defense station 68. The ccd video camera 66 hidden in cockpit panel in front of acting pilot take images and sound communication from sitting acting pilot and relay via internet along with flight data from the black box and sends it to the airline or FAA head quarters for safe keeping and retrieving as needed. Video camera take images of pilot and check against a list of the airlines employed pilots. It also sees his face and measure his width and height. Upon none matching with employee the system alert the airlines center. Under the pilot's seat the weight of the acting pilot is read and is compared to previous list of body weights of other employed pilots. The pilot's seat may have a weighing rubber container filled with water solution attached to pressure gauge or equivalent the computer reads and averages the weight index and compare to previous weights. Intruder usually has a different body weight than the usual employed fliers. Upon none matching weight the system alerts the airlines center for a closer verification.

What I claim is:

1. An anti highjacking system for airplanes, hardware and software comprising;
a- One or many counter hijacking stations inside the passenger's cabin and in the cockpit. Said defense station inside the passengers cabin has a motorized weapon, video camera viewer, and remote controller. Said video camera view fields of each station are simultaneously displayed on cockpit monitor in front of the pilot. Each of said stations has one of the following none-lethal or lethal defense tool: a gun with silencer, stunt gun, tranquilizer gun, arrow thrower with electrical wire and high voltage electric charge, wood hammer, head Bangor, stomach puncher, foot tripper, foot trap, body grabber, neck grabber, or a leg breaker. Hidden locations of said defense stations depends on station's function including cabin or cockpit, cabin ceiling above the walking isle, the floor below the walking isle, inside the cabin side walls, rear of cabin, cockpit door on the cabin side, and inside the cockpit. For ceiling stations the line of fire is towards isle or a dump empty target stretch away from passengers. The projectiles are none-lethal, none annoying, temporarily stunning or tranquilizing and safe. For side wall stations the line of fire is at a horizontal level above the heads of sitting passengers. Video cameras are mounted on these motorized or on fixed position targeting defense tools are used for rotation, designation, aiming at offenders and for manual or automatic firing.
b- Electrical connections for the pilot for remote control of each defense station to execute counter action against the attacker(s).
c- Wireless connections for the pilot for remote control of defensive counter-action and for remote viewing of gun sight field, remote aiming, and firing by pilot or by central or regional location of Police, InterPol, FBI, CIA, FAA, army, headquarters action, or instruction to allow the pilot or commanding post to shoot or immobilize or physically knockdown or tranquilize the one or multiple hijackers. The video and sound connection as well as aiming and firing are via realtime communication via internet, radio, cellular, or satellite means.
d- Computer software and video card to view the multiple video cameras on the pilot's screen.
e- Internet video conferencing software and hardware to connect to the stations in the airplane cabin, to pilot's computer and monitor, and agencies' centers.
f- A global positioning system (GPS) and reader of airplane speed, height, flight direction with a computer program to read red-light or no-fly-zone of any of GPS listed locations the airplane is approaching with an automatic sideways left or right turn deflection from potential target.
g- A remote control of flight direction and of evading an approaching no-fly-zone locations where the overriding flight remote control is operated by main center or headquarters of FAA, airlines, FBI, CIA, or any worldwide authorized entity.
h- Automatic alert and information system triggered by deviation from scheduled flight route or by approaching no-fly-zone.
i- Controlled opening big parachute of kite shape with corners attached to wing tips and to front and back body through hydrolics push-pull levers with adjustible tension and height where upon pulling down the the back corner the kite acts as a parachute to slow gravity fall onto land or unto water.

2. As in claim 1 a single gun with video camera defense station with silencer mounted on rear of cabin with line of fire is at chest level and with bullet path parallel to the service center isle path and with bullet absorber patch on the cockpit door. Said defence station is viewed on pilot's monitor and controlled by pilot via electric or mechanical wire. Said video camera connect to pilot's monitor via single cable.

3. As in claim 2 with the defense station mounted in the cockpit door aiming at isle walkers at chest level with absorbance patch at the rear of the cabin to stop the bullet that has no target ot that misses target.

4. As in claim 2 with a tranquilizer gun.

5. As in claim 2 with air gun that shoots high voltage stunt arrows.

6. As in claim 2 with air gun located in ceiling above the center isle to shoot high voltage stunt arrows downwards at a forward slant.

7. As in claim 2 with the defence station has pepper sprayer with adequate nozzle opening to reach the face of the intruder at a slanted direction.

8. As in claim 2 with the defense station has a pivoted flat board that is powered to swing down for a hard blow to the face of the offender.

9. As in claim 2 with the defense station having a heavy block and powered to repeatedly strike down on the head of the offender to yield him or them unconscious.

10. As in claim 2 with the defense station located at the floor of the walk isle powered to hit and break the femur or leg.

11. As in claim 1 with the cockpit camera facing the seated pilot and records flight events and send them to a saving location such as airlines or FAA via internet. Such voice and flight data from the black box go through the internet for remote saving as one file or as a backup files and for subsequent instant recovery.

12. As in claim 1 with computer and GPS reader with a list of target locations such as atomic reactors and dams of known GPS global positioning with a program to swerve the airplane from any such listed location if the plane altitude is low and where the computer program overrides the pilot's manual steering.

13. As in claim 1 with cockpit voice recorder black box 1 content and black box 2 flight data recorder of more thab 250 parameters are sent to internet files for safe keeping and recovery when the physical black box is not soon recovered, not recovered, or damaged.

14. As in claim 13 inflight early diagnosis system by realtime continuous sending of flight data parameters or portion of to airlines headquorters for predignosis and prevention action such as slowing speed when engine temperature is getting too hot (aspirin to lower temperature to prevent brain damage) with automatic bus or alert signal for failure prevention before mechanical failure occurs.

15. A controlled opening parachute for the whole airplane to safely land slowly at land or at water with parachute material tucked at center roof and center wings for not interfering with flying, with a lever on each corner of the kite-shaped parachute to force open the cloth material to a kite horizontal position to avoid sudden resistance shock caused by horizontal speed of the plane, and to gradual controlled pulldown of the rear corner of the parachute for gradually going down for softer vertical landing and slower horizontal speed.
